(19) United States
(12) Patent Application Publication
(10) Pub. No.: US 2014/0172492 A1
(43) Pub. Date: Jun. 19, 2014

(54) METHOD, SYSTEM, AND COMPUTER PROGRAM PRODUCT FOR PROVIDING CNG FILLING STATION OPTIMIZATIONS AND PROPOSALS

(71) Applicant: GENERAL ELECTRIC COMPANY, Schenectady, NY (US)

(72) Inventor: Dalbir Singh Utal, Houston, TX (US)

(73) Assignee: GENERAL ELECTRIC COMPANY, Schenectady, NY (US)

(21) Appl. No.: 13/719,846

(22) Filed: Dec. 19, 2012

(51) Int. Cl. G06Q 10/06; F17C 13/00

(52) U.S. Cl. CPC G06Q 10/06315; F17C 13/00
USPC 705/7.25

(57) ABSTRACT

Systems, methods, computer programs, and user interfaces are provided to receive a traffic profile from a user, where the traffic profile includes a CNG vehicle profile and an associated filling frequency profile, calculate an overall fill rate based on the CNG vehicle profile and the associated filling frequency profile, and generate a filling station configuration having a station fill rate greater than the overall fill rate, where the filling station configuration includes a compressor component, a storage component, a piping component, and a dispenser component.

### TECHNICAL FIELD

The present disclosure relates to a process for preparing compressed natural gas (CNG) filling station proposals. More specifically, embodiments of the present disclosure generate CNG filling station configurations based on a traffic flow profile provided by a user.

### BACKGROUND

CNG vehicles require specialized refueling delivery systems. U.S. Pat. No. 5,884,675 discloses one such system consisting of banks of cylinders each of which has an axially moveable piston, a pair of inlets, and an outlet. The cylinders are filled with CNG at a remote location and then transported to the refueling station. At the refueling station, hydraulic fluid is pumped from a reservoir into one end of each cylinder. The hydraulic fluid displaces the piston in each cylinder, forcing CNG through the outlet at the other end of the cylinder. The CNG flows through a hose into the vehicle being refueled, Each bank of cylinders is equipped with an accumulator located downstream from the outlets. When the cylinders are completely drained of CNG, the pressure in the accumulator moves each piston back to its starting position, forcing the hydraulic fluid out of the cylinders and back into the reservoir.

While this system represents an improvement over other CNG delivery systems, certain disadvantages remain. Refueling stations configurations vary depending on the vehicle traffic at the refueling location, making it difficult to provide optimal configurations fix differing traffic patterns; or rapidly optimizing for specific needs.

### SUMMARY

Various embodiments of systems, methods, computer programs, and user interfaces for providing CNG filling station optimizations and proposals. In some aspects, provided are a system, method, computer program, and user interface for receiving a traffic profile from a user, where the traffic profile includes a CNG vehicle profile and an associated filling frequency profile, calculating an overall fill rate based on the CNG vehicle profile and the associated filling frequency profile, and generating a filling station configuration having a station fill rate greater than the overall fill rate, where the filling station configuration includes a compressor component, a storage component, a piping component, and a dispenser component.

In some aspects, each of the compressor component, the storage component, the piping component, and the dispenser component further includes key performance data and cost data In some aspects, the key performance data includes at least one of inlet pressure, discharge pressure, compressor flow, storage volume, piping pressure drop, dispenser fill rate, and dispenser pressure drop.

In some aspects, the system, method, computer program, and user interface are further for receiving a configuration modification for the filling station configuration, the configuration modification updating at least one of the compressor component, the storage component, the piping component, and the dispenser component and generating an updating filling station configuration based on the configuration modification.

In some aspects, the system, method, computer program, and user interface are further for receiving an optimization profile for maximizing an optimization parameter for the filling station configuration, where the optimization parameter includes at least one of a fill rate parameter, storage volume parameter, and cost savings parameter. In some aspects, the optimization parameter includes the fill rate parameter, and the station fill rate of the filling station configuration exceeds the overall fill rate by at least the fill rate parameter. In some aspects, the optimization parameter includes the cost savings parameter, and the cost savings parameter specifies that a cost of the filling station configuration be minimized while maintaining the station fill rate to be greater than the overall fill rate.

### BRIEF DESCRIPTION OF THE DRAWINGS

FIGS. 1A-1C show an example user interface in accordance with one or more embodiments,

FIGS. 2 and 3A-3C show diagrams of systems in accordance with one or more embodiments.

FIGS. 4-5 show flow charts in accordance with one or more embodiments.

While the invention is susceptible to various modifications and alternative forms, specific embodiments thereof are shown by way of example in the drawings and will herein be described in detail. The drawings may not be to scale. it should be understood, however, that the drawings and detailed description thereto are not intended to limit the invention to the particular form disclosed, but to the contrary, the intention is to cover all modifications, equivalents, and alternatives falling within the spirit and scope of the present disclosure as defined by the appended claims.

### DETAILED DESCRIPTION

As discussed in more detail below, provided in some embodiments are systems and methods for generating a CNG filling station configuration based on a traffic flow profile provided by a user. In one embodiment, the process for generating a CNG filling station configuration includes the steps of receiving a traffic profile from a user, the traffic profile including CNG vehicle profile(s) and associated filling frequency profile(s), calculating an overall fill rate based on the CNG vehicle profile(s) and the associated filling frequency profile(s), and generating a filling station configuration having a station fill rate greater than the overall fill rate, the filling station configuration including a compressor component, a storage component, a piping component, and a dispenser component.

A CNG filling station configuration specifies a compressor component, a storage component, a piping to dispenser component, and a dispenser component for a filling station. In some embodiments, the CNG filling station configuration also includes data performance and cost data. CNG filling station configurations can be used to plan for the construction of CNG filling stations, For example, a CNG equipment retailer can use a CNG filling station configuration as a proposal to a prospective client, where the CNG filling station configuration is prepared in response to prospective client's requirements.

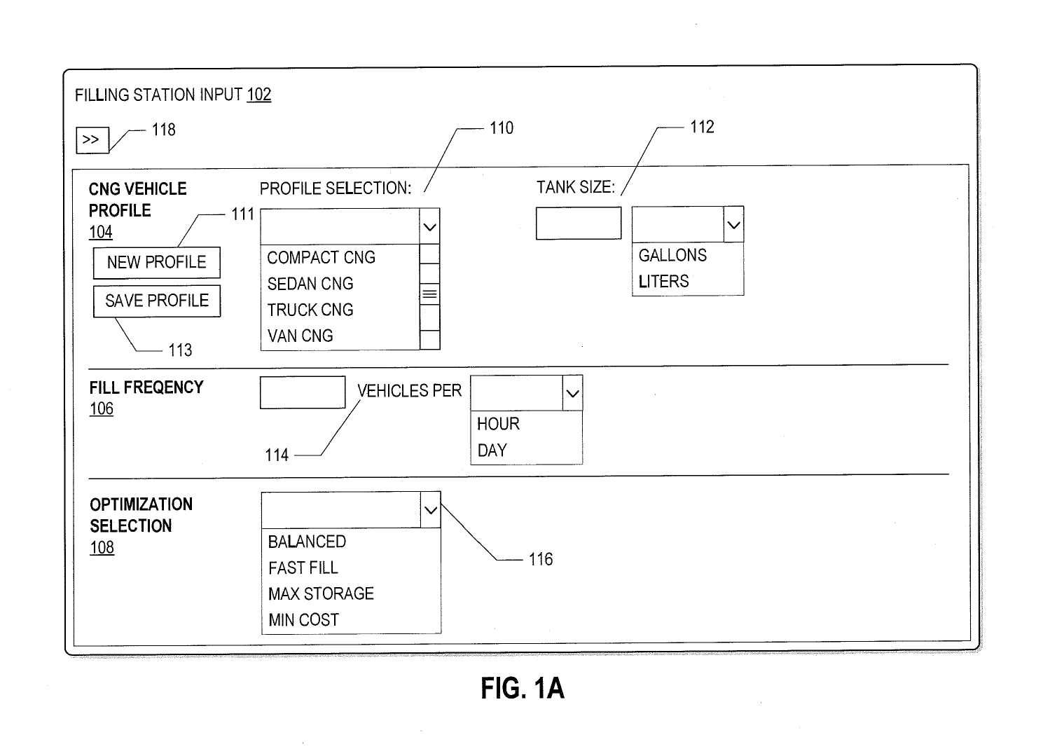

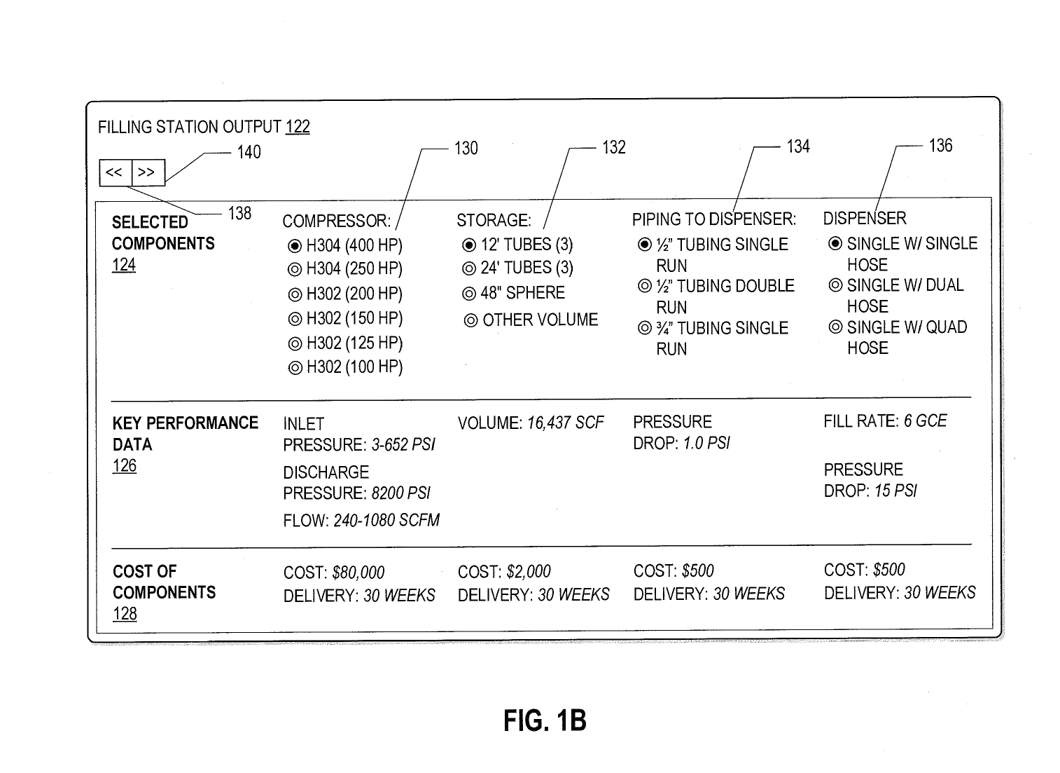

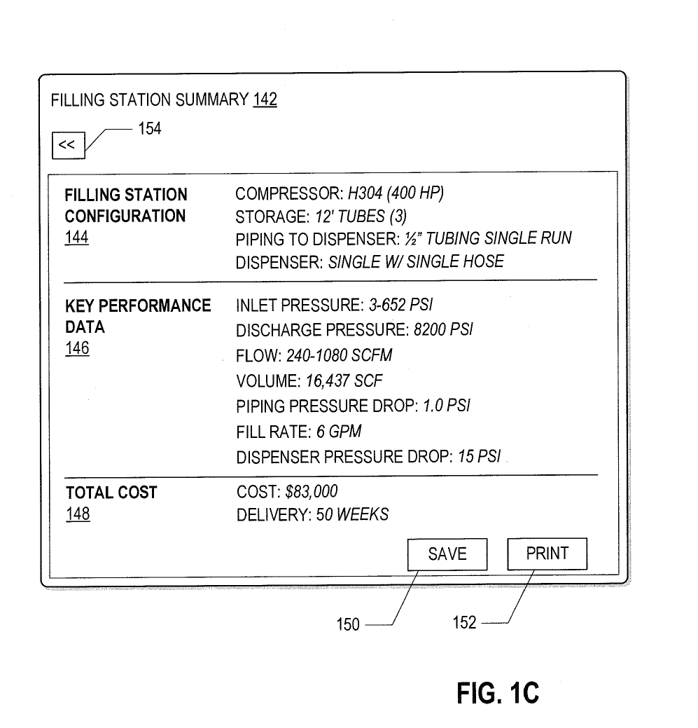

FIGS. 1A, 1B, and 1C show an example interface in accordance with embodiments of the invention. More specifically, FIGS. 1A, 1B, and 1C show an example user interface for generating a CNG filling station configuration.

In FIG. 1A, a filling station input screen 102 for collecting inputs from a user is shown, The filling station input screen 102 includes portions for allowing a user to specify a CNG vehicle profile 104, a fill frequency 106, and an optimization selection 108.

The CNG vehicle profile portion 104 allows a user to specify the type of vehicle powered by CNG that is expected to use the prospective filling station. The CNG vehicle profile portion 104 may include a profile selection dropdown list 110 from which the user selects a vehicle profile. Examples of vehicle profiles include, but are not limited to, CNG compact, CNG sedan, CNG truck, and CNG van. Each of the vehicle profiles is associated with a tank size that is shown in the tank size input 112 for the vehicle profile currently selected in the profile selection dropdown list 110. For example, a CNG compact car may have a tank size of 12 gallons whereas a CNG truck may have a tank size of 20 gallons.

In some embodiments, the user may select the new profile button 111 to create a new vehicle profile not currently listed in the profile selection dropdown list 110. Selecting the new profile button 111 creates a new entry in the profile selection dropdown list 110, where the user can specify a name for the new profile. The user may also specify a tank size for the new profile in the tank size input 112. Once the new profile has been entered, the user can select the save profile button 113 to save the new profile in, for example, a data record of a data repository.

The fill frequency portion 106 allows the user to specify the expected traffic over a given time period for the vehicle selected in the CNG vehicle profile portion 104. For example, the user can specify the number of vehicles per minute, hour, or day that the user expects to receive at the prospective filling station in the car frequency input 114. The inputs provided in the CNG vehicle profile portion 104 and the fill frequency portion 106 can be used to build a traffic profile for the user. For example, a traffic profile may specify that over the course of an hour, CNG will be dispensed to 100 CNG compact cars will arrive at the prospective filling station every hour. Based on the traffic profile, an overall fill rate can be calculated for the prospective filling station, where the overall fill rate is the minimum fill rate that should be attained by the prospective filling station in order to satisfy the CNG needs of the traffic profile. In this example, the overall fill rate could be calculated as (100 vehicles)(12 gallons per hour), which is 1200 gallons per hour (i.e., 2.7 standard cubic feet per minute), In some embodiments, the filling station input screen 102 may allow the user to select multiple vehicle profiles in the CNG vehicle profile portion 104, where frequency selections are made separately for each vehicle in the fill frequency portion 106.

The optimization selection portion 108 allows the user to specify an optimization profile for the prospective filling station. An optimization profile may be used to generate CNG filling station profiles that satisfy criteria such as balanced, fast fill, maximize storage, or minimize cost as shown in the optimization dropdown list 116. In this example, (1) a CNG filling station profile generated using a balanced criteria may balance the fill rate and the cost of the prospective filling station; (2) a CNG filling station profile generated using a fast fill criteria may maximize the fill rate of the prospective filling station while disregarding, wholly or in part, cost; (3) a CNG filling station profile generated using a maximum storage criteria may maximize the storage capacity of the prospective filling station while disregarded, wholly or in part, the cost and fill rate; and (4) a CNG filling station profile generated using a minimize cost criteria may minimize the cost of the prospective filling station while disregarding, wholly or in part, the fill rate.

After the user has completed his selections on the filling station input screen 102, the user can select the next button 118 to confirm. the selections and to move the user interface forward to the filling station output screen 122.

In FIG. 1B, the filling station output screen 122 for displaying outputs for a user is shown. The filling station output screen 122 includes portions for displaying selected components 124, key performance data 126, and cost of components 128.

The selected components portion 124 may display selected components for the filling station configuration on a compressor radial button 130, a storage radial button 132, a piping to dispenser radial button 134, and a dispenser radial button 136. The compressor radial button 130 includes selections for (1) an H304 compressor with a 400 HP motor; (2) and H304 compressor with a 250 HP motor; (3) an 1-1302 compressor with a 200 HP motor; (4) an H302 compressor with a 150 HP motor; (5) an H302 compressor with 125 HP motor; and (6) an H302 compressor with a 100 HP motor. In this example, the compressors correspond to H Series compressors manufactured by General Electric. The storage radial button 132 includes selections for (1) three 12′ storage tubes; (2) three 24′ storage tubes; and (3) a 48″ storage sphere. The piping to dispenser radial button 134 includes selections for (1) ½″ tubing single run; (2) ½″ tubing double run; and (3) ¾″ tubing single run. The dispenser radial button 136 includes selections for (1) a single dispenser with single hose; (2) a single dispenser with a dual hose; and (3) a single dispenser with a quad hose. One skilled in the art would appreciate that a variety of makes and models of components could be included in the component radial buttons described above.

In some embodiments, the selected components portion 124 may display the initial filling station configuration generated in response to the user's inputs collected on the filling station input screen 102. In some embodiments, the user can make alternative selections in the selected components portion 124.

The key performance data portion 126 displays various performance parameters for the components selected in the selected components portion 124. In this example, the key performance data portion 126 shows (1) inlet pressure, discharge pressure, and flow for the compressor component 130; (2) volume for the storage component 132; (3) pressure drop for the piping to dispenser component 134; and (4) fill rate and pressure drop for the dispenser component 136. As the user modifies the selections in the selected components portion 124, the key performance data portion 126 can be updated accordingly to reflect the modified selection.

The cost of components portion 128 displays cost parameters for the components selected in the selected components portion 124. In this example, the cost of components portion 128 shows the purchase cost and delivery cost for each of the selected components. As the user modifies the selections in the selected components portion 124, the cost of components portion 128 can be updated accordingly to reflect the modified selection.

The user can select the previous button 138 to return the user interface to the filling station input screen 102. After the user returns to the filling station input screen 102, the user can modify his initial input selections (e.g., CNG vehicle profile selection, fill frequency selection, optimization profile selection) as discussed above. Alternatively, after the user has confirmed the selections on the filling station output screen 122, the user can select the next button 140 to submit the selections and to move the user interface forward to the filling station summary screen 142.

In FIG. 1C, the filling station summary screen 142 for displaying a summary for a filling station configuration with the components selected is shown. The filling station summary screen 142 includes portions for displaying the filling station configuration 144, key performance data 146, and total cost 148.

The filling station configuration portion 144 shows the components that were confirmed for the filling station configuration on the filling station output screen 122. Correspondingly, key performance data for the confirmed components are shown in the key performance data portion 146. The total cost portion 148 shows the total purchase cost and the total delivery cost of all the components in the filling station configuration. The user can perform a final review of the generated filling station configuration shown in the filling station summary 142. After the user has approved the generated filling station configuration, the user can save a copy of the summary by selecting the save button 150 and/or print a copy of the summary by selecting the print button 152.

If the user does not approve of the filling station configuration shown on the tilling station summary screen 142, the user may select the back button 154 to return the user interface to the filling station output screen 122. After the user returns to the filling station output screen 122, the user can modify his component selections as discussed above.

In other embodiments, the example interface described above may be simplified. For example, the interface may not include the filling station output screen 122 so that clicking the next button 118 moves the user interface from the filling station input screen 102 directly to the filling station summary screen 142. Further, certain portions of the interface such as the optimization selection portion 108 may be excluded. In this case, the tilling station configuration may be generated as discussed above using a default optimization profile.

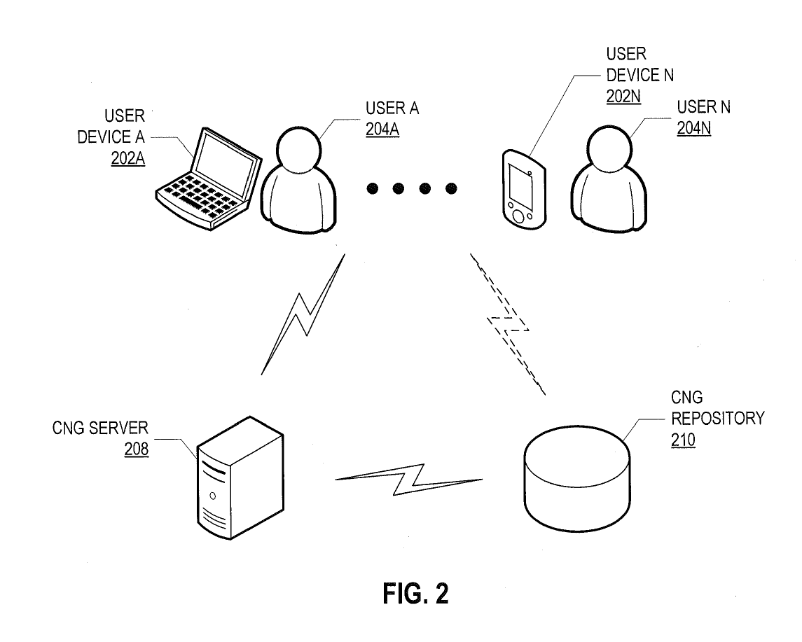

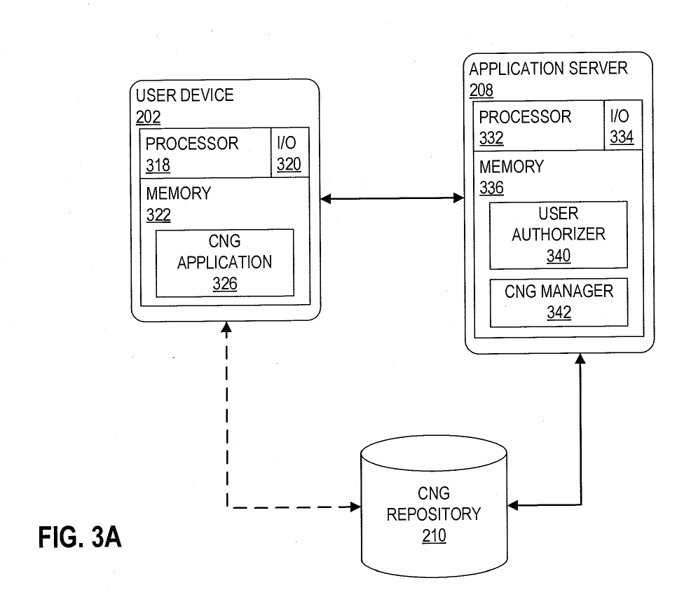

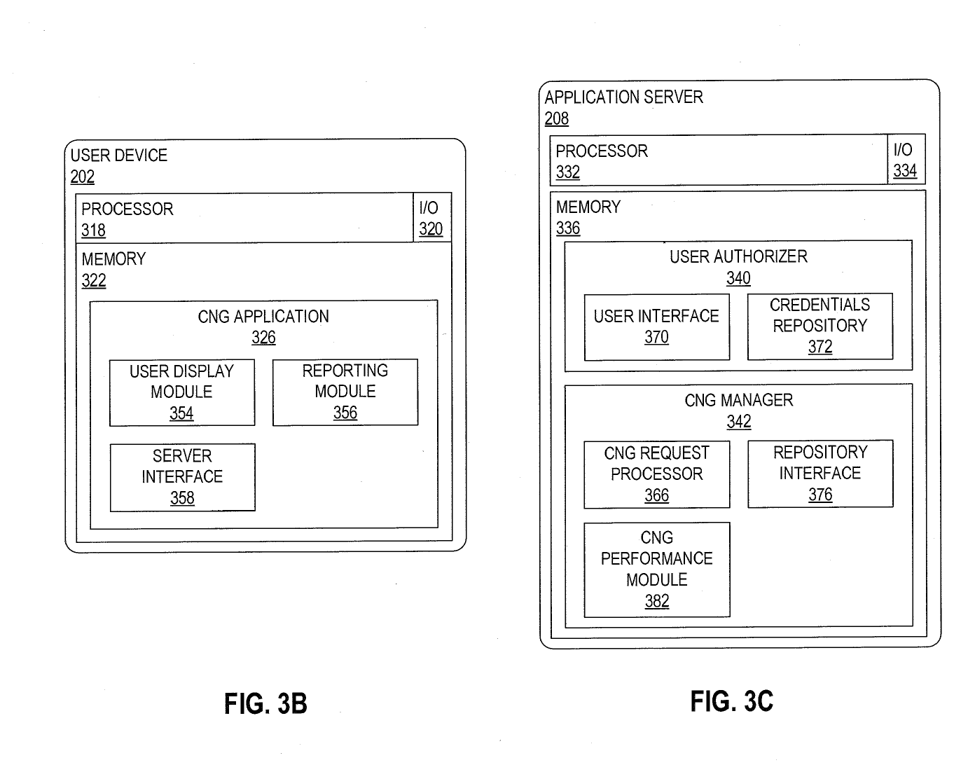

FIG. 2 shows a diagram of a system in accordance with one embodiment. The system of this embodiment includes user devices (e.g., user device A 202A and user device N 202N) interacting with CNG server(s) 208. Further, the illustrated CNG server 208 stores information in a CNG repository 210. FIGS. 3A-3C describes further aspects of the aforementioned components of FIG. 2.

Examples of user devices (e.g., user device A 202A, user device N 202N) include desktop computers, smartphones, tablet computers, laptop computers, etc. Each of the user devices (e.g., user device A 202A, user device N 202N) is configured with a web application, such as a web browser, for accessing web services. As shown in FIG. 2, the user devices (e.g., user device A 202A, user device N 202N) in this example are operated by users (e.g., user A 204A, user N 204N).

In some embodiments, the CNG server(s) 208 may be implemented on multiple computing devices (i.e., servers), where a load balancing scheme distributes requests across the multiple computing devices. The CNG server 208 may be configured to provide CNG-related services to the user devices (e.g., user device A 202A, user device N 202N). For example, the CNG server 208 may be configured to provide CNG filling station configurations in response to vehicle profile(s) and corresponding frequency information from a user device. The CNG server 208 may also be configured manage CNG-related data in the CNG repository 210. Specifically, the CNG server 208 may process and store (1) information (e.g., performance data, specifications, etc.) associated with various filling station components such as compressors, storage, piping, and dispensers; (2) information (e.g., tank capacity) associated with CNG vehicles; and (3) optimization profiles for generating filling station configurations that satisfy particular criteria balanced, minimize cost, maximize fill rate, etc.).

In other embodiments, the CNG-related services can be provided directly by an application executed on the user devices (e.g., user device A 202A, user device N 202N) rather than by a CNG server 208 as discussed above. In this case, a CNG repository 210 can be stored in local memory or storage of the user devices (e.g., user device A 202A, user device N 202N).

FIG. 3A shows a diagram of a system in accordance with some embodiments of the invention. The example system includes a user device 202 interacting with an CNG server 208. Further, the CNG server 208 of this embodiment stores information in a CNG repository 210.

In some embodiments, the user device 202 is a computing device. For example, the user device 202 may be a desktop computer, a laptop computer, a smartphone, a tablet computer, or other computing device capable of accessing CNG-related services. In some embodiments, the user device 202 includes a processor 318, an input/output module 320, and a memory 322. The user device 202 may be implemented as a computing device with an operating system, stored in the memory 322, for interacting with a user. For example, the operating system may be configured to provide applications (e.g., web applications, user applications, etc) to the user. The input/output module 320 of the user device 202 may include an input module, such as a keyboard and/or a mouse, and an output module, such as a printer and/or a monitor. In some embodiments, the memory 322 includes a CNG application 326.

In some embodiments, the CNG application 326 of the user device 202 is configured to provide a user interface for obtaining a CNG filling station configuration for a user. For example, the CNG application 326 may he configured to (1) obtain CNG filling station configurations from a CNG server 208 and/or (2) present the CNG filling station configurations for review by the user of the user device 202. In some embodiments, the CNG filling station configurations may be stored on a local, tangible storage medium (e.g., random access memory, flash memory, etc.) of the user device 202.

In sonic embodiments, the CNG application 326 may further include a user display module 354 of FIG. 3B that is configured to present a user interface for obtaining filling station configurations. The user interface presented by the user display module 354 of FIG. 3B may be substantially similar to the user interface described above with respect to FIG. 1A-1C. In some embodiments, the user display module 354 of FIG. 3B is configured to process inputs from a user and obtain a filling station configuration based on the inputs.

In some embodiments, the CNG application 326 may further include a reporting module 356 of FIG. 3B that is configured to generate reports for filling station configurations. For example, the reporting module 356 of FIG. 3B is configured to prepare a report as discussed above with respect to FIG. 1C, The reporting module 356 of FIG. 3B may be configured to prepare reports in a variety of formats capable of being printed from or saved on the user device 202.

In some embodiments, the CNG application 326 may include a server interface 358 of FIG. 3B that is configured to provide user input to the CNG server 208. For example, the server interface 358 of FIG. 3B may provide user input obtained by the user display module 354 of FIG. 3B to the CNG server 208 along with a request for a CNG filling station configuration based on the user input.

Referring back to FIG. 3A, in some embodiments, the CNG server 208 is a computing device configured to provide application services to a number of client devices such as the user device 202. In some embodiments, the CNG server 208 includes a processor 332, an input/output module 334, and a memory 336. The CNG server 208 may include various types of computing devices that execute an operating system. The processor 332 may execute instructions, including instructions stored in the memory 336. The instructions, like the other instructions executed by computing devices herein, may be stored on a non-transitory computer readable medium such as an optical disk (e.g., compact disc, digital versatile disk, etc.), a flash drive, a hard drive, or any other computer readable storage device. The CNG server 208 may be connected to a local area network (LAN) or a wide area network (e.g., the Internet) via a network interface connection.

In some embodiments, the memory 336 includes a user authorizer 340 and a CNG manager 342. The aforementioned components of the CNG server 208 may be implemented on multiple computing devices (i.e., servers), where a load balancing scheme distributes requests across the multiple computing devices.

In some embodiments, the user authorizer 340 of the CNG server 208 is configured to manage user sessions for user devices 202. For example, the user authorizer module 340 of this embodiment includes a user interface 370 of FIG. 3C configured to authenticate credentials from the user device 202 when initiating a user session. In this example, the user device 202 is not authorized to interact with the CNG server 208 until the credentials are confirmed to be valid by the user interface 370 of FIG. 3C. In some embodiments, the user authorizer 340 also includes a credentials repository 372 of FIG. 3C configured to store encrypted credentials used to authorize the users of the CNG server 208.

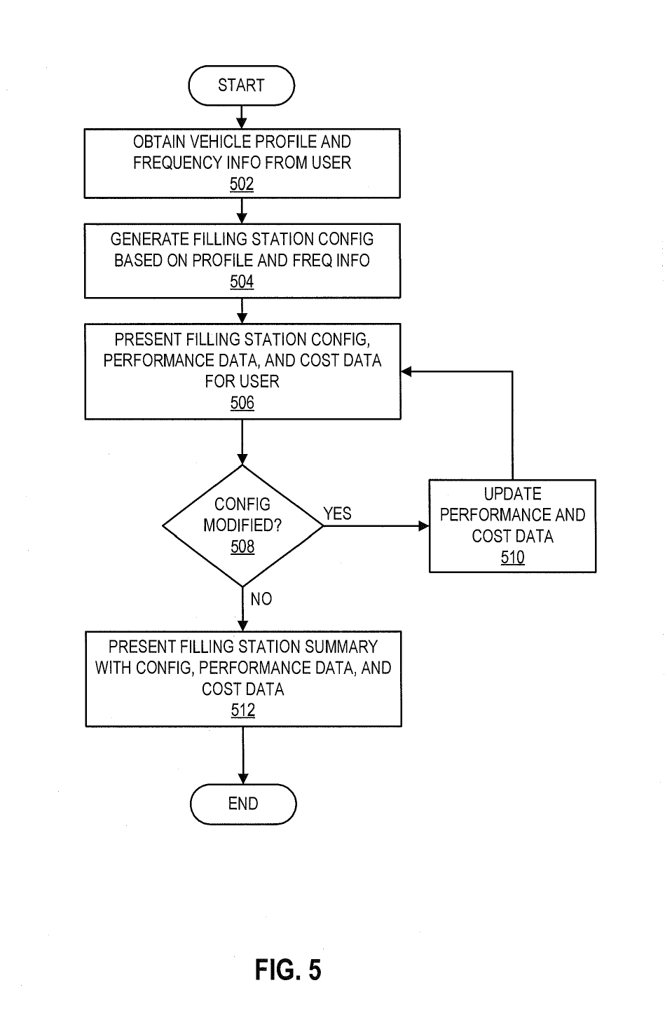

In some embodiments, the CNG manager 342 of the CNG server 208 is configured to generate filling station configurations for user devices 202. Specifically, the CNG manager module 342 may include: (1) a CNG request processor 366 of FIG. 3C configured to process requests for filling station configurations from user devices; (2) a repository interface 376 of FIG. 3C configured to store and manage CNG data in the CNG repository 210; and (3) a CNG performance module 382 of FIG. 3C configured to generate the filling station configurations based on user input received from user devices 202. For example, the CNG manager module 342 may be configured to generate filling station configurations as discussed below with respect to FIG. 5.

In some embodiments, the CNG performance module 382 of FIG. 3C of the CNG manager module 342 may be configured to generate CNG filling station configurations based on the user input received from user devices 202. The CNG performance module 382 of FIG. 3C may be configured to determine a target fill rate based on the user inputs. For example, the CNG performance module 382 of FIG. 3C may be configured to determine the fill rate required to fill the tanks of CNG vehicles as specified in a traffic profile received from a user device 202. In this example, the CNG performance module 382 of FIG. 3C may also be configured to generate filling station configurations based on, in part, the calculated fill rate.

In some embodiments, the repository interface 376 of FIG. 3C is configured to store CNG-related data in the CNG repository 210. For example, the repository interface 376 of FIG. 3C may store filling station component data in the CNG repository 210 that is used to provide CNG-related services. In this example, the repository interface 376 of FIG. 3C may also be configured to retrieve and provide the CNG-related data to the user device 202. In another example, the filling station component data may be provided by the repository interface 376 of FIG. 3C to user devices 202, allowing the user devices 202 to present a CNG user interface as discussed above. The CNG repository 210 may correspond to a server, a database, files, a memory cache, etc. that is stored locally (e.g., located on the CNG server) or shared on a network (e.g., a database server). In some embodiments, the user device 202 may interact directly with the CNG repository 210 to obtain CNG-related data such as filling station component data.

In some embodiments, the CNG repository 210, or a related repository, is configured to store information related to the filling station component data, vehicle profiles, optimization profiles, etc. For example, the CNG repository 210 may also store results of analysis (e.g., filling station configurations, etc,) performed on the stored CNG-related data.

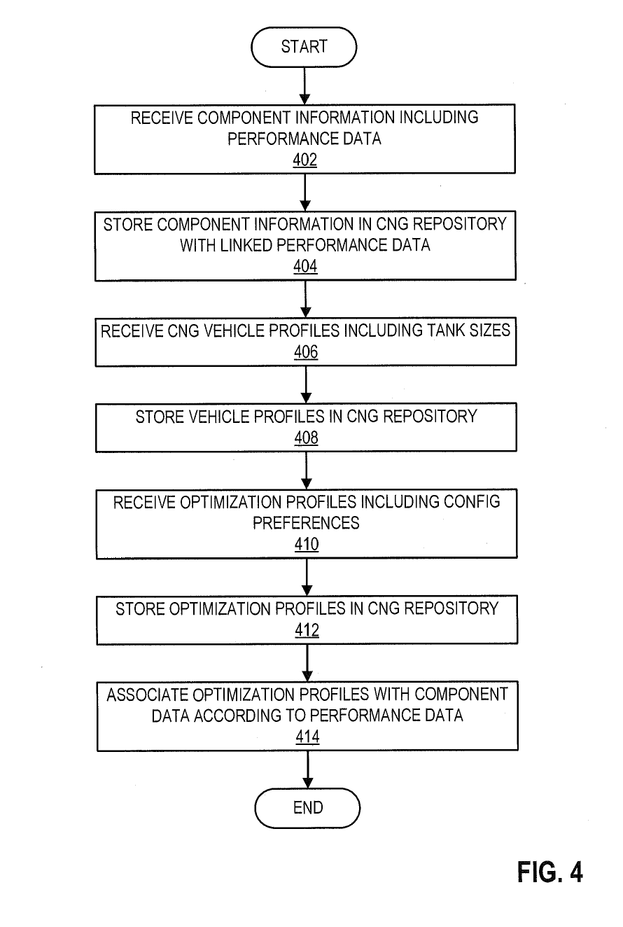

FIG. 4 shows a flow chart in accordance with certain embodiments. More specifically, FIG. 4 is a flow chart of a method performed by a CNG server to load CNG-related data into a CNG repository. As is the case with the other processes described herein, various embodiments may not include all of the steps described below, may include additional steps, and may sequence the steps differently. Accordingly, the specific arrangement of steps shown in FIG. 4 should not be construed as limiting the scope of the invention.

In step 402 of this embodiment, filling station component information is received by the CNG server. The filling station component information includes data such as key performance data that describe the operating parameters of various filling station components. For example, as shown in FIG. 1B, the filling station component information can include key performance data for compressors (e.g., inlet pressure, discharge pressure, flow), storage (e.g., volume), piping (e.g., pressure drop), and dispensers (e.g., fill rate, pressure drop).

In step 404 of this embodiment, the filling station component information is stored in the CNG repository. For example, a data record may be created for each of the various components, where each data record is related to key performance data for the corresponding component. The component data records may be stored such that the CNG server can query the data records based on the key performance data (e.g., retrieve all compressors with flow sufficient to provide an overall fill rate greater than a target fill rate).

In step 406 of this embodiment, CNG vehicle profiles are received by the CNG server. The vehicle profiles include descriptions of the vehicles (e.g., make, model, year, etc.) and data such as tank size and gas mileage that describe the CNG fuel requirements of the vehicles.

In step 408, the CNG vehicle profiles are stored in the CNG repository. For example, a data record may be created for each CNG vehicle profile, where each data record includes data describing the fuel requirements for the corresponding vehicle. In this example, the vehicle profile data records may be stored such that the CNG server can query the data records based on the description of the vehicle (e.g., retrieve the tank size of a vehicle with a particular name).

In step 410, optimization profiles for generating filling station configurations are received by the CNG server. The optimization profiles may include filling station configuration preferences such as described above with respect to FIG. 1A. Examples of optimization profiles include, but are not limited to, a balanced profile, a fast fill profile, a maximize storage profile, and a minimize cost profile. Each of the optimization profiles specifies a preference for one or more operating parameters to account for when generating a filling station configuration. For example, a fast fill profile may specify that the fill rate of the compressor and/or dispenser should be maximized for the filling station configuration. In another example, the minimize cost profile may specify that the cost of the filling station configuration should be minimized while still ensuring that the overall fill rate of the configuration exceeds the target fill rate.

In step 412 of this embodiment, the optimization profiles are stored in the CNG repository. A data record may be created for each optimization profile, where each data record specifies criteria for operating parameters of generated filling station configurations.

In step 414, the optimization profiles may be associated with component data according to the key performance data of the components. For example, the storage with the greatest capacity may be associated with the maximize storage optimization profile. In another example, only the compressors and dispensers with fill rates greater than a threshold fill rate may be associated with the fast fill optimization profile. The associations with component data may be used to generate tilling station configurations as discussed below with respect to FIG. 5.

FIG. 5 shows a flow chart in accordance with certain embodiments. More specifically, FIG. 5 is a flow chart of a method performed by a CNG server to generate a CNG filling station configuration. As is the case with the other processes described herein, various embodiments may not include all of the steps described below, may include additional steps, and may sequence the steps differently. Accordingly, the specific arrangement of steps shown in FIG. 5 should not be construed as limiting the scope of the invention.

In step 502 of this embodiment, a vehicle profile and frequency information is obtained from a user. The vehicle profile may be a description of a car including information such as make, model, and tank size. The frequency information may specify the frequency at which the vehicle described in the vehicle profile is projected to visit the prospective tilling station. In some embodiments, multiple vehicle profiles for different types of vehicles along with associated frequency information for each of the vehicle profiles may be provided from the user. The combination of the vehicle profile(s) and associated frequency information may be considered to be the traffic profile for the prospective filling station.

In step 504 of this embodiment, a CNG filling station configuration is generated based on the traffic profile. The traffic profile can be used to calculated a target filling rate for the prospective filling station. For example, based on the type and frequency of vehicles that are projected to arrive at the prospective filling station, the target filling rate can be calculated as, for example, the number of vehicles per hour times the tank size of the vehicle divided by 60 minutes in order to determine the minimum standard cubic feet per minute (SCFM) that should be provided by the prospective tilling station. The minimum SCFM of the prospective filling station can then be used to determine the components that should be included in the CNG filling station configuration. Specifically, the operating parameters of the filling station components are considered to select a filling station configuration that has a station fill rate that is at least as great than the minimum SCFM. In some embodiments, the station fill rate is the rate of flow of CNG that can be dispensed by a filling station built according to the filling station configuration. In an optional embodiment, a value of a flow rate of fluid being dispensed is displayed in units of gas gallons equivalent (GGE).

In step 506 of this embodiment, the CNG filling station configuration is presented to the user for review. For example, the CNG filling station configuration can be presented as described above with respect to FIG. 1B. In this example, the presentation includes performance (e.g., inlet pressure, discharge pressure, flow rate, storage volume, etc.) and cost data for each of the filling station components shown in the CNG filling station configuration. The presentation of the CNG filling station configuration may allow the user to modify the configuration by selecting other filling station components.

In step 508 of this embodiment, a determination is made as to whether the CNG filling station configuration presented in step 506 has been modified by the user. If the CNG filling station configuration has been modified, the presentation of the CNG filling station configuration is updated with revised performance and cost data according to the modifications in step 510. In this manner, the user can iteratively update the CNG filling station configuration while continuously reviewing the updated performance and cost data until the user approves of the revised configuration.

Once the user approves the CNG filling station configuration (i.e., no modifications are made by the user to the configuration), a CNG filling station summary may be presented to the user in step 512. For example, the CNG filling station summary may be presented as described above with respect to FIG. 1C. The filling station summary can include the user-approved CNG filling station configuration along with corresponding performance and cost data. In some embodiments, the user interface may allow the user to print and/or save a copy of the filling station summary. Further, the interface may also allow the user to submit a purchase order for the components shown in the approved CNG filling station configuration.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present embodiments may suitably comprise, consist or consist essentially of the elements disclosed and may be practiced in the absence of an element not disclosed.

As used throughout this application, the word “may” is used in a permissive sense meaning having the potential to), rather than the mandatory sense (i.e., meaning must), The words “include”, “including”, and “includes” mean including, but not limited to. As used throughout this application, the singular forms “a”, “an” and “the” include plural referents unless the content clearly indicates otherwise. Thus, for example, reference to “an element” includes two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

We claim:

1. A computer-implemented method of providing compressed natural gas (CNG) filling station optimizations and proposals, the computer-implemented method comprising:
receiving a traffic profile from a user, the traffic profile comprising one or more CNG vehicle profiles and associated filling frequency profiles;
calculating an overall fill rate based on the one or more CNG vehicle profiles and the associated filling frequency profiles; and
generating a filling station configuration having a station fill rate that is at least as great as the overall fill rate, the filling station configuration comprising a compressor component, a storage component, a piping component, and a dispenser component.

2. The computer-implemented method of claim 1, wherein each of the compressor component, the storage component, the piping component, and the dispenser component further comprises key performance data and cost data.

3. The computer-implemented method of claim 2, wherein the key performance data comprises at least one of a group consisting of inlet pressure, discharge pressure, compressor flow, storage volume, piping pressure drop, dispenser fill rate, and dispenser pressure drop.

4. The computer-implemented method of claim 1, further comprising:
receiving a configuration modification for the filling station configuration, the configuration modification updating at least one of the compressor component, the storage component, the piping component, and the dispenser component; and
generating an updating filling station configuration based on the configuration modification.

5. The computer-implemented method of claim 1, further comprising:
receiving an optimization profile for maximizing an operating parameter for the filling station configuration, the operating parameter comprising at least one of a fill rate parameter, storage volume parameter, and cost savings parameter.

6. The computer-implemented method of claim 5, wherein the optimization parameter comprises the fill rate parameter, and wherein the station fill rate of the filling station configuration exceeds the overall rate by at least the fill rate parameter.

7. The computer-implemented method of claim 5, wherein the operating parameter comprises the cost savings parameter, and wherein the cost savings parameter specifies that a cost of the filling station configuration be minimized white maintaining the station fill rate to be greater than the overall fill rate.

8. A system, comprising:
one or more memories;
one or more processors, each operatively connected to the one or more memories;
a user interface stored on the one or more memories and configured to be executed by the one or more processors to receive a traffic profile from a user, the traffic profile comprising one or more CNG vehicle profiles and associated filling frequency profiles; and
a compressed natural gas (CNG) performance module stored on the one or more memories and configured to be executed by the one or more processors to:
calculate an overall fill rate based on the one or more CNG vehicle profiles and the associated filling frequency profiles, and
generate a filling station configuration having a station fill rate greater than the overall fill rate, the filling station configuration comprising a compressor component, a storage component, a piping component, and a dispenser component.

9. The system of claim 8, wherein each of the compressor component, the storage component, the piping component, and the dispenser component further comprises key performance data and cost data.

10. The system of claim 8, wherein the key performance data comprises at least one of a group consisting of inlet pressure, discharge pressure, compressor flow, storage volume, piping pressure drop, dispenser rate, and dispenser pressure drop.

11. The system of claim 8,
wherein the user interface is further configured to be executed by the one or more processors to receive a configuration modification for the filling station configuration, the configuration modification updating at least one of the compressor component, the storage component, the piping component, and dispenser component; and
and wherein CNG performance module is further configured to be executed by the one or more processors to generate an updating filling station configuration based on the configuration modification.

12. The system of claim 8, wherein the user interface is further configured to be executed one or more processors to:
receiving an optimization profile for maximizing an operating parameter for the filling station configuration, the operating parameter comprising at least one of a fill rate parameter, storage volume parameter, and cost savings parameter.

13. The system of claim 12, wherein the operating parameter, comprises the fill rate parameter, and wherein the station fill rate of the filling station configuration exceeds the overall fill rate by at least the fill rate parameter.

14. The system of claim 12, wherein the operating parameter comprises the cost savings parameter, and wherein the cost savings parameter specifies that a cost of the filling station configuration be minimized while the station fill rate is greater than the overall fill rate.

15. A non-transitory computer readable medium having computer-executable program instructions embodied therein that when executed cause a computer processor to:
receive a traffic profile from a user, the traffic profile comprising one or more CNG vehicle profiles and associated filling frequency profiles;
calculate an overall fill rate based on the one or more CNG vehicle profiles and the associated filling frequency profiles; and
generate a filling station configuration having a station fill rate greater than the overall fill rate, the filling station configuration comprising a compressor component, a storage component, a piping component, and a dispenser component.

16. The computer readable medium of claim 15, wherein each of the compressor component, the storage component, the piping component, and the dispenser component further comprises key performance data and cost data.

17. The computer readable medium of claim 15, wherein the key performance data comprises at least one of a group consisting of inlet pressure, discharge pressure, compressor flow, storage volume, piping pressure drop, dispenser fill rate, and dispenser pressure drop.

18. The computer readable medium of claim 15, wherein the instructions when executed further cause the computer processor to:
receive a configuration modification for the filling station configuration, the configuration modification updating at least one of the compressor component, the storage component, the piping component, and the dispenser component; and
generate an updating filling station configuration based on the configuration modification.

19. The computer readable medium of claim 15, wherein the instructions when executed further cause the computer processor to:
receive an optimization profile for maximizing an operating parameter for the filling station configuration, the operating parameter comprising at least one of a fill rate parameter, storage volume parameter, and cost savings parameter.

20. The computer readable medium of claim 19, wherein the operating parameter comprises the fill rate parameter, and wherein the station fill rate of the filling station configuration exceeds the overall fill rate by at least the fill rate parameter.

21. The computer readable medium of claim 19, wherein the operating parameter comprises the cost savings parameter, and wherein the cost savings parameter specifies that a cost of the filling station configuration be minimized white maintaining the station fill rate to be greater than the overall fill rate
